(19) United States
(12) Patent Application Publication
(10) Pub. No.: US 2022/0019772 A1
(43) Pub. Date: Jan. 20, 2022

(54) Image Processing Method and Device, and Storage Medium

(71) Applicant: Shenzhen Sensetime Technology Co., Ltd., Shenzhen (CN)

(72) Inventors: Chengkai Zhu, Shenzhen (CN); Xuesen Zhang, Shenzhen (CN); Wei Wu, Shenzhen (CN); Liwei Huang, Shenzhen (CN); Dong Liang, Shenzhen (CN)

(73) Assignee: Shenzhen Sensetime Technology Co., Ltd., Shenzhen (CN)

(21) Appl. No.: 17/488,631

(22) Filed: Sep. 29, 2021

Related U.S. Application Data
(63) Continuation of application No. PCT/CN2020/093779, filed on Jun. 1, 2020.

(30) Foreign Application Priority Data
Aug. 30, 2019 (CN) 201910818028.9

(51) Int. Cl. G06K 9/00; G06F 16/55; G06F 16/583

(52) U.S. Cl. CPC G06K 9/00288; G06K 9/00268; G06F 16/583; G06F 16/55; G06K 9/00362

(57) ABSTRACT

The present disclosure relates to an image processing method and apparatus. The method comprises: performing face and body feature extraction on an image to be processed to obtain image features including face features and/or body features, and the image to be processed comprises a first image and a second image; performing a face clustering operation, according to the face features extracted from the first image, to obtain a face clustering result; performing a body clustering operation on the second image to obtain a body clustering result, according to the face clustering result and the body features extracted from the first and second images, no face feature has been extracted from the second image; and obtaining, according to the face clustering result and the body clustering result, a clustering result for the image to be processed. The method can improve the recall rate while ensuring the accuracy of the clustering result.

### CROSS-REFERENCE TO RELATED APPLICATION

This application is a continuation of and claims the under 35 U.S.C. 120 to PCT Application No. PCT/CN2020/093779, filed on Jun. 1, 2020, which claims the priority to Chinese Patent Application No. 201910818028.9 filed with China National Intellectual Property Administration, on Aug. 30, 2019, entitled “Image Processing Method and Apparatus, Electronic Device and Storage Medium”. All the above reference priority documents are incorporated herein by reference in their entireties.

### TECHNICAL FIELD

The present disclosure relates to the technical field of artificial intelligence, and particularly to an image processing method and apparatus, an electronic device and a storage medium.

### BACKGROUND

With the development of relevant technologies, face searching has been widely used, especially when tracking down a criminal in the public security industry, it is necessary to search an image of an unidentified suspect in a massive image database. On this basis, it is necessary to establish an information database in which one person corresponds to one profile. In the information base, images of a same person belong to a same category.

In relevant technologies, the images may be clustered by a face clustering method so as to establish the above information base.

### SUMMARY

The present disclosure provides an image processing technical solution.

According to an aspect of the present disclosure, there is provided an image processing method, which includes:

Performing face feature extraction and body feature extraction on images to be processed to obtain image features of the images, wherein the image features include at least one of face features or body features, and the images to be processed include first images and second images;

Performing a face clustering operation on the first images from which the face features are extracted according to the extracted face features to obtain a face clustering result;

Performing a body clustering operation on the second images from which no face feature is extracted according to the face clustering result, the body features extracted from the second images and the body features extracted from the first images from which the body features are extracted to obtain a body clustering result; and

Obtaining a clustering result for the images to be processed according to the face clustering result and the body clustering result.

According to an aspect of the present disclosure, there is provided an image processing device, which includes:

a processor; and

a memory configured to store processor executable instructions,

wherein the processor is configured to execute instructions stored in the memory to execute the above image processing method.

According to an aspect of the present disclosure, there is provided a non-transitory computer readable storage medium having computer program instructions stored thereon, wherein when the computer program instructions are executed by a processor, the processor is caused to perform the above image processing method.

In this way, according to the image processing method and apparatus provided by the embodiments of the present disclosure, the face clustering may be performed on the first images from which the face features can be extracted in the face clustering way to determine the category of the first images, thereby obtaining the face clustering result. The body clustering is performed on the second image and the first image from which the face features cannot be extracted in the body clustering way, and the category of the second image is further determined according to the face clustering result of the first image, thus obtaining the clustering result of the image to be processed.

It should be understood that the above general descriptions and the following detailed descriptions are only exemplary and illustrative, rather limit the present disclosure.

Other features and aspects of the present disclosure will become apparent from the following detailed descriptions of exemplary embodiments with reference to the accompanying drawings.

### BRIEF DESCRIPTION OF THE DRAWINGS

The drawings described here are incorporated into the specification and constitute a part of the specification. The drawings illustrate embodiments in conformity with the present disclosure and are used to explain the technical solutions of the present disclosure together with the specification.

FIG. 1 illustrates a flow chart of an image processing method according to an embodiment of the present disclosure.

FIG. 2 illustrates a schematic diagram of the image processing method according to an embodiment of the present disclosure.

FIG. 3 illustrates a structural schematic diagram of an image processing apparatus according to an embodiment of the present disclosure.

FIG. 4 illustrates a block diagram of an electronic device 800 according to an exemplary embodiment.

FIG. 5 illustrates a block diagram of an electronic device 1900 according to an exemplary embodiment.

### DETAILED DESCRIPTION

Various exemplary embodiments, features and aspects of the present disclosure are described in detail below with reference to the accompanying drawings. Reference numerals in the drawings refer to elements with same or similar functions. Although various aspects of the embodiments are illustrated in the drawings, the drawings are unnecessary to draw to scale unless otherwise specified.

The term “exemplary” herein means “using as an example and an embodiment or being illustrative”. Any embodiment described herein as “exemplary” should not be construed as being superior or better than other embodiments.

The term “and/or” used herein is only an association relationship describing the associated objects, which means that there may be three relationships, for example, A and/or B may mean three situations: A exists alone, both A and B exist, and B exists alone. Furthermore, the term “at least one of ” herein means any one of a plurality of or any combinations of at least two of a plurality of, for example, “including at least one of A, B and C” may represent including any one or more elements selected from a set consisting of A, B and C.

Furthermore, for better describing the present disclosure, numerous specific details are illustrated in the following detailed description. Those skilled in the art should understand that the present disclosure may be implemented without certain specific details. In some examples, methods, means, elements and circuits that are well known to those skilled in the art are not described in detail in order to highlight the main idea of the present disclosure.

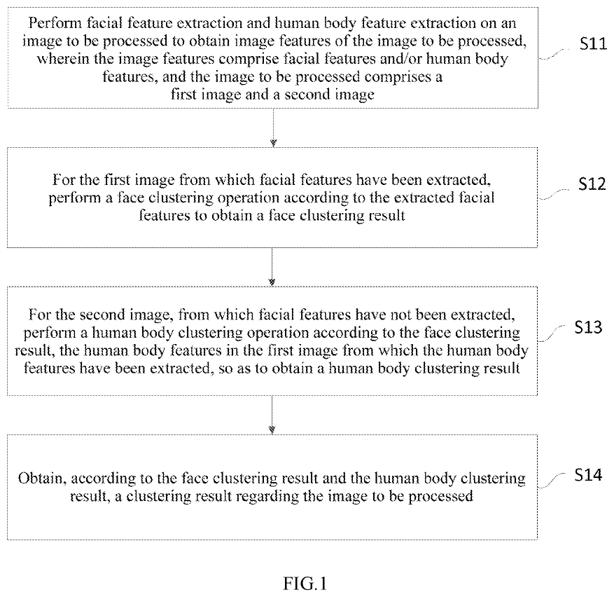

FIG. 1 illustrates a flow chart of an image processing method according to an embodiment of the present disclosure. The image processing method may be executed by a terminal device or other processing devices. The terminal device may be user equipment (UE), a mobile device, a user terminal, a terminal, a cellular phone, or a cordless telephone, a personal digital assistant (PDA), a handheld device, a computing device, a vehicle-mounted device, a wearable device, etc. Other processing device may be a server, a cloud server, etc. In a possible implementation, the image processing method may be implemented by calling computer readable instructions stored in the memory with the processor.

As shown in FIG. 1, the method includes the following steps S11-S14:

Step S11: performing face feature extraction and body feature extraction on images to be processed to obtain image features of the images, wherein the image features include at least one of face features or body features, and the images to be processed include first images and second images.

For example, the images to be processed may be images acquired by an image acquiring device (such as a camera), or may be stored images or video frames which are input directly.

For example, neural networks such as Convolutional Neural Network and the like may be used to perform the face feature extraction and body feature extraction on the images to be processed to obtain the image features (at least one of face features or body features) of the images. For example, after the face feature extraction and body feature extraction are performed on multiple images to be processed, the face features may be extracted from a portion of the multiple images, and thus the portion of the multiple images may be determined as the first images. The first images may be divided into images from which the face features are only extracted but no body features are extracted and images from which both the face features and body features are extracted. The other portion of the multiple images to be processed from which no face features are extracted but the body features are extracted may be determined as second images. The present disclosure does not limit the type of the neural network and does not limit the manner for extracting the face features and the body features.

In a possible implementation, the face features may be feature information determined according to key points of the face, such as positions and shapes of five sense organs and may also include the information such as skin color. The body features may be feature information determined according to key points of the body, such as height, body shape, leg length, arm length, etc., and may also include the information such as clothing style and color.

Step S12: performing a face clustering operation on the first images from which the face features are extracted according to the extracted face features to obtain a face clustering result.

For example, the images to be processed from which the face features are extracted may be determined as the first images. The images from which no face feature is extracted but the body features are extracted may be determined as the second images. The face clustering operation may be performed according to the face features extracted from the first images. For example, the face clustering is performed on multiple first images to obtain the face clustering result. Alternatively, prior to the current clustering operation, the clustering is already performed in advance according to historical images, and the images are already stored in the image database according to the existing category, so that the first images may be clustered into the existing category, and the images that cannot be clustered into the existing category are re-clustered to obtain the face clustering result.

It may be illustrative that the above face clustering operation may utilize any clustering way among K-MEANS algorithm, K-MEDOIDS algorithm, CLARANS algorithm, etc. The present disclosure does not make any specific limitation to the clustering way for performing the face clustering operation.

Step S13: performing a body clustering operation on the second images from which no face feature is extracted according to the face clustering result, the body features extracted from the second images, and the body features extracted from the first images from which the body features are extracted to obtain a body clustering result.

Step S14: obtaining a clustering result for the images to be processed according to the face clustering result and the body clustering result.

The body clustering operation may be performed on the first images from which both the face features and the body features are extracted and the second images from which no face image is extracted according to the extracted body features, and the first images which belong to a same category as the second images are determined to obtain the body clustering result.

Further, the face clustering result and the body clustering result may be fused to obtain a clustering result of the images to be processed.

It may be illustrative that the above body clustering operation may utilize any clustering way among K-MEANS algorithm, K-MEDOIDS algorithm, CLARANS algorithm, etc. The present disclosure does not make any specific limitation to the manner of clustering for performing the body clustering operation.

In this way, according to the image processing method provided by the embodiments of the present disclosure, the face clustering may be performed on the first images from which the face features can be extracted in the face clustering way to determine the category of the first images, thereby obtaining the face clustering result. The body clustering may be performed on the first images as well as the second images from which no face features are extracted in the body clustering way to further determine the category of the second images according to the face clustering result of the first images, thereby obtaining the clustering result of the images to be processed. Since the embodiments of the present disclosure combine the face clustering way and the body clustering way, the recall rate of the clustering result is increased while ensuring the accuracy of the clustering result.

In a possible implementation, the face clustering result may include a first result. The step of performing the face clustering operation on the first images from which the face features are extracted according to the extracted face features to obtain the face clustering result may include:

acquiring a face clustering center of at least one existing category in an image database; and

performing face clustering according to the face clustering center of the at least one existing category and the face features extracted from the first images to cluster the first images into the existing category so as to obtain the first result of the first images.

For example, prior to the current clustering operation, the clustering is already performed in advance according to historical images, and the historical images are already stored in the image database according to the category determined by the clustering result. The face clustering center and body clustering center of at least one existing category obtained by the clustering operation may be also stored the image database. For any one of the existing categories, the face clustering center may be a mean value of the face features extracted from the images corresponding to the existing category. The body clustering center may be a mean value of the body features extracted from the images corresponding to the existing category.

The face clustering center of at least one existing category may be acquired from the image database. Similarity between the face features of the first images and the face clustering center of the at least one existing category man be determined to further determine an existing category to which the first images belong according to the similarity, thereby clustering the first images into the existing category to obtain the first result of the first images.

In a possible implementation, the face clustering result may include a second result. The step of performing the face clustering operation on the first images from which the face features are extracted according to the extracted face features to obtain the face clustering result further includes:

performing the face clustering operation on the first images which are not clustered into the existing category to obtain the second result of the first images.

For example, for at least one first image which is not clustered into the existing category, the face clustering operation may be performed again according to the face features extracted from the first image to cluster at least one first image into a new category to obtain the second result of the first images.

It may be illustrative that there are 7 first images at present (i.e., an image 1 to be processed, an image 2 to be processed, an image 3 to be processed, an image 4 to be processed, an image 5 to be processed, an image 6 to be processed, and an image 7 to be processed) and there are 6 existing categories (i.e., a person 1, a person 2, a person 3, a person 4, a person 5, and a person 6) in the image database, the face clustering centers of the 6 existing categories may be acquired respectively and the face clustering operation may be executed respectively according to the face features extracted from the 7 first images and the face clustering centers of the 6 existing categories, thereby obtaining a first result that the image 1 to be processed belongs to the person 1 and both the image 3 to be processed and the image 5 to be processed belong to the person 4. The face clustering operation is performed on the image 2 to be processed, the image 4 to be processed, the image 6 to be processed and the image 7 to be processed which are not clustered to the existing categories according to the extracted face features, thereby obtaining a second result that both the image 2 to be processed and the image 6 to be processed belong to the same category (i.e., the person 7), the image 4 to be processed belongs to a category (i.e., the person 8), and the image 7 to be processed belongs to a category (i.e., the person 9). The first result and the second result are merged to obtain the face clustering result of the first images.

In a possible implementation, the body clustering result may include a third result. After the face clustering operation is completed, the step of performing the body clustering operation on the second images from which no face feature is extracted according to the face clustering result, the body features extracted from the second images, and the body features extracted from the first images from which the body features are extracted to obtain a body clustering result includes:

performing the body clustering operation on any one of the second images according to the body features extracted from the first images from which the body features are extracted and the body features in the second images to obtain a body clustering sub-result;

determining the first images which belong to the same body category as the second images according to the body clustering result; and

adding the second images into the category of the first images which belong to the same body category as the second images according to the face clustering result to obtain the third result.

Any one of the second images may be clustered into the category of the first images which are already clustered. For example, the first images from which the body features are extracted are determined. The body clustering operation is performed on the second images and the first images according to the body features extracted from the first images and the body features extracted from the second image, and the first images which belong to the same category as the second images are determined. The category of the first images which belong to the same category as the second images is determined according to the face clustering result, and the second images are further determined to belong to the category of the first images, thereby obtaining the third result. The clustering operation may be performed on the images to be processed according to the face clustering result and the third result to obtain the clustering result.

In a possible implementation, the body clustering result may include a fourth result. The step of performing the body clustering operation on any one of the second images from which no face feature is extracted according to the face clustering result, the body features extracted from the second images, and the body features extracted from the first images from which the body features are extracted to obtain the body clustering result includes:

acquiring body clustering center of at least one existing category in the image database;

performing the body clustering operation on the second images which are not clustered into the face category according to the body features in the second images and the body clustering center of the at least one existing category to cluster the second images into the existing category so as to obtain the fourth result.

For example, the body clustering center of at least one existing category may be acquired from the image database. Similarity between the body features of the second images and the body clustering center of the at least one existing category can be determined to further determine an existing category to which the second images belong, thereby clustering the second images into the existing category to obtain the fourth result of the second images. The clustering operation may be performed on the images to be processed according to the face clustering result, the third result and the fourth result to obtain the clustering result.

It may be illustrative that there are 12 images to be processed at present, including 7 first images from which the face images are extracted (for example, the body features may be extracted from the image 1 to be processed, the image 2 to be processed, the image 3 to be processed, the image 4 to be processed and the image 5 to be processed, and no body feature may be extracted from the image 6 to be processed and the image 7 to be processed) and 5 second images from which no face image is extracted (i.e., an image 8 to be processed, an image 9 to be processed, an image 10 to be processed, an image 11 to be processed, and an image 12 to be processed). The performance of the face clustering operation on the 7 first images can refer to the above examples, which is not repeated herein.

The body clustering operation is performed on the 5 second images respectively according to the body features extracted from the second images and the body features extracted from the first images from which the body features are extracted (i.e., the image 1 to be processed, the image 2 to be processed, the image 3 to be processed, the image 4 to be processed, and the image 5 to be processed). The third result obtained by the body clustering operation is that the image 9 to be processed and the image 2 to be processed belong to the same category (i.e., the person 7), the image 10 to be processed and the image 3 to be processed belong to the same category (i.e., the person 4), and the image 12 to be processed and the image 4 to be processed belong to the same category (i.e., the person 8).

For the image 8 to be processed and the image 11 to be processed which are not clustered into the face category, the body clustering centers of 6 existing categories may be acquired respectively, and the body clustering operation is executed respectively according to the body features extracted from 2 second images and the body clustering centers of 6 existing categories, and the obtained fourth result is that the image 8 to be processed belongs to the person 1 and the image 11 to be processed belongs to the person 3.

The clustering operation for the 12 images to be processed is completed, thereby obtaining the clustering result of the 12 images to be processed that the image 1 to be processed and the image 8 to be processed belong to the same category (i.e., the person 1); the image 2 to be processed, the image 6 to be processed and the image 9 to be processed belong to the same category (i.e., the person 7); the image 3 to be processed, the image 5 to be processed and the image 10 to be processed belong to the same category (i.e., the person 4); the image 4 to be processed and the image 12 to be processed belong to the same category (i.e., the person 8); the image 7 to be processed belongs to a category (i.e., the person 9); and the image 11 to be processed belongs to the person 3.

In a possible implementation, the method may further include:

adding the images to be processed into the image database according to the clustering result; and

updating both the face clustering center and the body clustering center of at least one existing category in the image database according to the images to be processed.

For example, after the clustering operation for the images to be processed is completed, a category to which at least one image to be processed belong may be determined according to the clustering result, thereby storing the at least one image to be processed into the image database according to the corresponding category and further updating both the face clustering center and the body clustering center of the at least one category according to the images to be processed stored into the at least one category.

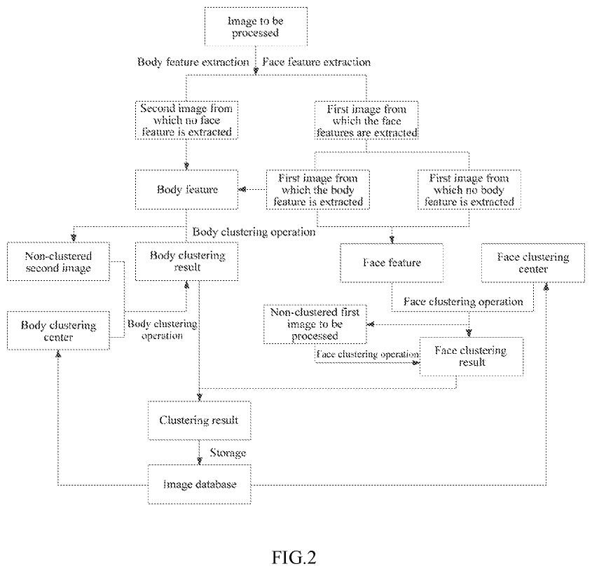

To make those skilled in the art understand better the embodiments of the present application, the embodiments of the present application may be described below in conjunction with examples as shown in FIG. 2.

The face feature extraction and body feature extraction are performed on the images to be processed, and then the images to be processed from which the face features are extracted are determined as the first images and the images from which no face feature is extracted are determined as the second images.

The face clustering operation performed on the first images according to the face features extracted from the first images includes: clustering the first images into existing categories according to the face clustering centers of the existing categories in the image database to obtain the first result; performing the face clustering operation again on the first images which are not clustered into the existing categories to generate a new category so as to obtain the second result, thereby determining a category to which the at least one first image belongs and finally obtaining the face clustering result according to the first result and the second result.

Performing the body clustering operation on the second images according to the extracted body features includes: executing the body clustering operation on the second images and the first images from which the body features are extracted, determining the first images which belong to the same category as the second images, and clustering the second images into the face category to obtain the third result; for the second images which are not clustered into the face category, clustering the second images into the existing categories according to the body clustering center of the existing category in the image database to obtain the fourth result, thereby determining the category to which the at least one second image belongs and finally obtaining the body clustering result according to the third result and the fourth result.

The body clustering result and the face clustering result may be fused to obtain the final clustering result. The images to be processed are stored into the image database according to the clustering result, and the face clustering center and the body clustering center of each category are updated according to the images to be processed.

It may be illustrative that the images to be processed may be clustered, and the images to be processed may be stored based on the categories to which the images belong according to the clustering result according to the image processing method provided by the embodiments of the present disclosure. For example, the public security organizations may more accurately establish profiles of human according to image and video clues of faces and bodies so as to better grasp the information of suspects, track the trajectory of the suspect, issue early warnings, crack criminals, etc.

It may be understood that the above method embodiments described in the present disclosure may be combined with each other to form combined embodiments without departing from principles and logics, which are not repeated in the present disclosure due to space limitation.

Furthermore, the present disclosure further provides an image processing apparatus, an electronic device, a computer-readable storage medium and a program, all of all of which may be used to implement any image processing method provided by the present disclosure. For the corresponding technical solutions and descriptions, please refer to the corresponding records in the method section, which will not be repeated.

It will be appreciated by those skilled in the art that in the above method of the specific implementation, the order of each step does not mean a strict execution order to constitute any limitation to the implementation process, and the specific execution order of each step should be determined by the functions and possible internal logics.

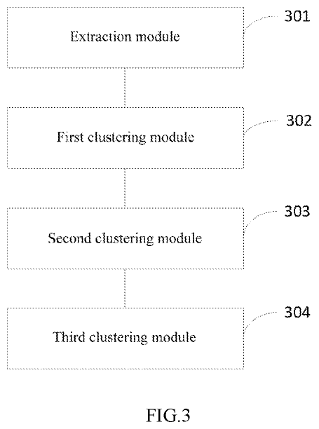

FIG. 3 illustrates a structural schematic diagram of an image processing apparatus according to an embodiment of the present disclosure. As shown in FIG. 3, the apparatus may include:

an extraction module 301, which may be configured to perform face feature extraction and body feature extraction on images to be processed to obtain image features of the images, wherein the image features include at least one of face features or body features, and the images to be processed include first images and second images;

a first clustering module 302, which may be configured to perform a face clustering operation on the first images from which the face features are extracted according to the extracted face features to obtain a face clustering result;

a second clustering module 303, which may be configured to perform a body clustering operation on the second images from which no face feature is extracted according to the face clustering result, the body features extracted from the second images, and the body features extracted from the first images from which the body features are extracted to obtain a body clustering result; and

a third clustering module 304, which may be configured to obtain a clustering result for the images to be processed according to the face clustering result and the body clustering result.

In some embodiments of the present disclosure, functions or modules of the apparatus provided in the embodiments of the present disclosure may be used to execute the method described in the above method embodiments, and its specific implementation and technical effect thereof may refer to the above descriptions of the method embodiments, and are not repeated herein for brevity.

In a possible implementation, the face clustering result may include a first result. The first clustering module is further configured to:

acquire a face clustering center of at least one existing category in an image database; and

perform face clustering according to a face clustering center of the at least one existing category and the face features extracted from the first images, and cluster the first images into the existing category to obtain the first result of the first images.

In a possible implementation, the face clustering result further includes a second result. The first clustering module is further configured to:

perform the face clustering operation on the first images which are not clustered into the existing category to obtain the second result of the first images.

In a possible implementation, the body clustering result includes a third result. The second clustering module is further configured to:

perform the body clustering operation on any one of the second images according to the body features extracted from the first images from which the body features are extracted and the body features in the second images to obtain a body clustering sub-result;

determine the first images which belong to a same body category as the second images according to the body clustering sub-result; and

add the second images into the category of the first images which belong to the same body category as the second images according to the face clustering result to obtain the third result.

In a possible implementation, the body clustering result further includes a fourth result. The second clustering module is further configured to:

acquire a body clustering center of at least one existing category in the image database; and

perform the body clustering operation on the second images which are not clustered into the face category according to the body features in the second images and the body clustering center of the at least one existing category to cluster the second images into the existing category to obtain the fourth result.

In a possible implementation, the apparatus further includes:

an addition module, configured to add the images to be processed into the image database according to the clustering result;

an updating module, configured to update both the face clustering center and body clustering center of at least one category in the image database according to the images to be processed. In some embodiments, functions or modules of the apparatus provided in the embodiments of the present disclosure may be used to execute the method described in the above method embodiments, which may be specifically implemented by referring to the above descriptions of the method embodiments, and are not repeated here for brevity.

An embodiment of the present disclosure further provides a computer readable storage medium having computer program instructions stored thereon, wherein the computer program instructions, when executed by a processor, implement the above method. The computer readable storage medium may be a non-volatile computer readable storage medium.

An embodiment of the present disclosure further provides an electronic device, which includes a processor and a memory configured to store processor executable instructions, wherein the processor is configured to execute the above method.

An embodiment of the present disclosure further provides a computer program product, which includes computer readable codes. When the computer readable codes are run on the electronic device, the processor in the electronic device executes the above image processing method.

The electronic device may be provided as a terminal, a server or a device in any other form.

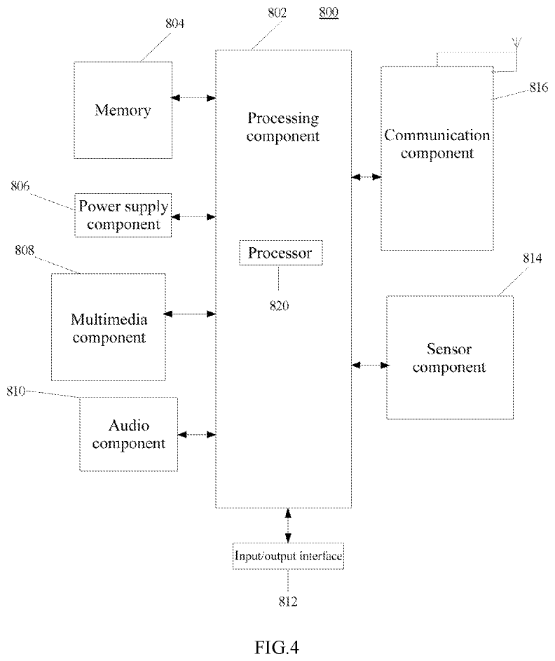

FIG. 4 illustrates a block diagram of an electronic device 800 according to an exemplary embodiment. For example, the electronic device 800 may be a mobile phone, a computer, a digital broadcast terminal, a message transceiver, a game console, a tablet device, medical equipment, fitness equipment, a personal digital assistant or any other terminal.

Referring to FIG. 4, the electronic device 800 may include one or more of the following components: a processing component 802, a memory 804, a power supply component 806, a multimedia component 808, an audio component 810, an input/output (I/O) interface 812, a sensor component 814 and a communication component 816.

The processing component 802 generally controls the overall operation of the electronic device 800, such as operations related to display, phone call, data communication, camera operation and record operation. The processing component 802 may include one or more processors 820 to execute instructions so as to complete all or some steps of the above method. Furthermore, the processing component 802 may include one or more modules for interaction between the processing component 802 and other components. For example, the processing component 802 may include a multimedia module to facilitate the interaction between the multimedia component 808 and the processing component 802.

The memory 804 is configured to store various types of data to support the operations of the electronic device 800. Examples of these data include instructions for any application or method operated on the electronic device 800, contact data, telephone directory data, messages, pictures, videos, etc. The memory 804 may be any type of volatile or non-volatile storage device or a combination thereof, such as static random access memory (SRAM), electronic erasable programmable read-only memory (EEPROM), erasable programmable read-only memory (EPROM), read-only memory (ROM), a magnetic memory, a flash memory, a magnetic disk or a compact disk.

The power supply component 806 supplies electric power to various components of the electronic device 800. The power supply component 806 may include a power supply management system, one or more power supplies, and other components related to the power generation, management and allocation of the electronic device 800.

The multimedia component 808 includes a screen providing an output interface between the electronic device 800 and a user. In some embodiments, the screen may include a liquid crystal display (LCD) and a touch panel (TP). If the screen includes the touch panel, the screen may be implemented as a touch screen to receive an input signal from the user. The touch panel includes one or more touch sensors to sense the touch, sliding, and gestures on the touch panel. The touch sensor may not only sense a boundary of the touch or sliding action, but also detect the duration and pressure related to the touch or sliding operation. In some embodiments, the multimedia component 808 includes a front camera and/or a rear camera. When the electronic device 800 is in an operating mode such as a shooting mode or a video mode, the front camera and/or the rear camera may receive external multimedia data. Each front camera and rear camera may be a fixed optical lens system or have a focal length and optical zooming capability.

The audio component 810 is configured to output and/or input an audio signal. For example, the audio component 810 includes a microphone (MIC). When the electronic device 800 is in the operating mode such as a call mode, a record mode and a voice identification mode, the microphone is configured to receive the external audio signal. The received audio signal may be further stored in the memory 804 or transmitted via the communication component 816. In some embodiments, the audio component 810 also includes a loudspeaker which is configured to output the audio signal.

The I/O interface 812 provides an interface between the processing component 802 and a peripheral interface module. The peripheral interface module may be a keyboard, a click wheel, buttons, etc. These buttons may include but are not limited to a home button, a volume button, a start button and a lock button.

The sensor component 814 includes one or more sensors which are configured to provide state evaluation in various aspects for the electronic device 800. For example, the sensor component 814 may detect an on/off state of the electronic device 800 and relative positions of the components such as a display and a small keyboard of the electronic device 800. The sensor component 814 may also detect the position change of the electronic device 800 or a component of the electronic device 800, presence or absence of a user contact with electronic device 800, directions or acceleration/deceleration of the electronic device 800 and the temperature change of the electronic device 800. The sensor component 814 may include a proximity sensor configured to detect the presence of nearby objects without any physical contact. The sensor component 814 may further include an optical sensor such as a CMOS or CCD image sensor which is used in an imaging application. In some embodiments, the sensor component 814 may further include an acceleration sensor, a gyroscope sensor, a magnetic sensor, a pressure sensor or a temperature sensor.

The communication component 816 is configured to facilitate the communication in a wired or wireless manner between the electronic device 800 and other devices. The electronic device 800 may access a wireless network based on communication standards, such as WiFi, 2G or 3G, or a combination thereof. In an exemplary embodiment, the communication component 816 receives a broadcast signal or broadcast related information from an external broadcast management system via a broadcast channel. In an exemplary embodiment, the communication component 816 further includes a near field communication (NFC) module to facilitate short range communication. For example, the NFC module may be implemented on the basis of radio frequency identification (RFID) technology, infrared data association (IrDA) technology, ultrawide band (UWB) technology, Bluetooth (BT) technology and other technologies.

In exemplary embodiments, the electronic device 800 may be implemented by one or more application dedicated integrated circuits (ASIC), digital signal processors (DSP), digital signal processing devices (DSPD), programmable logic devices (PLD), field programmable gate arrays (FPGA), controllers, microcontrollers, microprocessors or other electronic elements and is used to execute the above method.

In an exemplary embodiment, there is further provided a non-volatile computer readable storage medium, such as a memory 804 including computer program instructions. The computer program instructions may be executed by a processor 820 of an electronic device 800 to implement the above method.

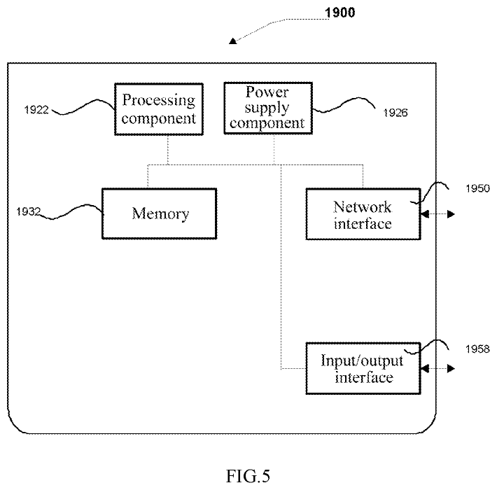

FIG. 5 illustrates a block diagram of an electronic device 1900 according to an exemplary embodiment. For example, the electronic device 1900 may be provided as a server. Referring to FIG. 5, the electronic device 1900 includes a processing component 1922, and further includes one or more processors and memory resources represented by a memory 1932 and configured to store instructions executed by the processing component 1922, such as an application program. The application program stored in the memory 1932 may include one or more modules each corresponding to a group of instructions. Furthermore, the processing component 1922 is configured to execute the instructions so as to execute the above method.

The electronic device 1900 may further include a power supply component 1926 configured to perform power supply management on the electronic device 1900, a wired or wireless network interface 1950 configured to connect the electronic device 1900 to a network, and an input/output (I/O) interface 1958. The electronic device 1900 may run an operating system stored in the memory 1932, such as Windows Server™, Mac OS X™, Unix™, Linux™, FreeBSD™ or the like.

In an exemplary embodiment, there is further provided a non-volatile computer readable storage medium, such as a memory 1932 including computer program instructions. The computer program instructions may be executed by a processing module 1922 of an electronic device 1900 to execute the above method.

The present disclosure may be implemented by a system, a method, and/or a computer program product. The computer program product may include a computer readable storage medium having computer readable program instructions for causing a processor to carry out the aspects of the present disclosure stored thereon.

The computer readable storage medium may be a tangible device that may retain and store instructions used by an instruction executing device. The computer readable storage medium may be, but not limited to, e.g., electronic storage device, magnetic storage device, optical storage device, electromagnetic storage device, semiconductor storage device, or any proper combination thereof. A non-exhaustive list of more specific examples of the computer readable storage medium includes: portable computer diskette, hard disk, random access memory (RAM), read-only memory (ROM), erasable programmable read-only memory (EPROM or Flash memory), static random access memory (SRAM), portable compact disc read-only memory (CD-ROM), digital versatile disk (DVD), memory stick, floppy disk, mechanically encoded device (for example, punch-cards or raised structures in a groove having instructions recorded thereon), and any proper combination thereof. A computer readable storage medium referred herein should not be construed as transitory signal per se, such as radio waves or other freely propagating electromagnetic waves, electromagnetic waves propagating through a waveguide or other transmission media (e.g., light pulses passing through a fiber-optic cable), or electrical signal transmitted through a wire.

Computer readable program instructions described herein may be downloaded to individual computing/processing device from a computer readable storage medium or to an external computer or external storage device via network, for example, the Internet, local region network, wide region network and/or wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium in the respective computing/processing devices.

Computer readable program instructions for carrying out the operations of the present disclosure may be assembler instructions, instruction-set-architecture (ISA) instructions, machine instructions, machine-related instructions, microcode, firmware instructions, state-setting data, or source code or object code written in any combination of one or more programming languages, including an object oriented programming language, such as Smalltalk, C++ or the like, and the conventional procedural programming languages, such as the “C” programming language or similar programming languages. The computer readable program instructions may be executed completely on the user's computer, partly on the user's computer, as a stand-alone software package, partly on the user's computer and partly on a remote computer, or completely on a remote computer or a server. In the scenario with remote computer, the remote computer may be connected to the user's computer through any type of network, including local region network (LAN) or wide region network (WAN), or connected to an external computer (for example, through the Internet connection from an Internet Service Provider). In some embodiments, electronic circuitry, such as programmable logic circuitry, field-programmable gate arrays (FPGA), or programmable logic arrays (PLA), may be customized from state information of the computer readable program instructions; and the electronic circuitry may execute the computer readable program instructions, so as to achieve the aspects of the present disclosure.

Aspects of the present disclosure have been described herein with reference to the flowchart and/or the block diagrams of the method, device (systems), and computer program product according to the embodiments of the present disclosure. It will be appreciated that each block in the flowchart and/or the block diagram, and combinations of blocks in the flowchart and/or block diagram, may be implemented by the computer readable program instructions.

These computer readable program instructions may be provided to a processor of a general purpose computer, a dedicated computer, or other programmable data processing device, to produce a machine, such that the instructions create means for implementing the functions/acts specified in one or more blocks in the flowchart and/or block diagram when executed by the processor of the computer or other programmable data processing devices.

These computer readable program instructions may also be stored in a computer readable storage medium, wherein the instructions cause a computer, a programmable data processing device and/or other devices to function in a particular manner, such that the computer readable storage medium having instructions stored therein includes a product that includes instructions implementing aspects of the functions/acts specified in one or more blocks in the flowchart and/or block diagram.

The computer readable program instructions may also be loaded onto a computer, other programmable data processing devices, or other devices to have a series of operational steps performed on the computer, other programmable devices or other devices, so as to produce a computer implemented process, such that the instructions executed on the computer, other programmable devices or other devices implement the functions/acts specified in one or more blocks in the flowchart and/or block diagram.

The flowcharts and block diagrams in the drawings illustrate the architecture, function, and operation that may be implemented by the system, method and computer program product according to the various embodiments of the present disclosure. In this regard, each block in the flowchart or block diagram may represent a part of a module, a program segment, or a portion of code, which includes one or more executable instructions for implementing the specified logical function(s). In some alternative implementations, the functions denoted in the blocks may occur in an order different from that denoted in the drawings. For example, two contiguous blocks may, in fact, be executed substantially concurrently, or sometimes they may be executed in a reverse order, depending upon the functions involved. It will also be noted that each block in the block diagram and/or flowchart, and combinations of blocks in the block diagram and/or flowchart, may be implemented by dedicated hardware-based systems performing the specified functions or acts, or by combinations of dedicated hardware and computer instructions.

Although the embodiments of the present disclosure have been described above, it will be appreciated that the above descriptions are merely exemplary, but not exhaustive; and that the disclosed embodiments are not limiting. A number of variations and modifications may occur to one skilled in the art without departing from the scopes and spirits of the described embodiments. The terms in the present disclosure are selected to provide the best explanation on the principles and practical applications of the embodiments and the technical improvements to the arts on market, or to make the embodiments described herein understandable to one skilled in the art.

What is claimed is:

1. An image processing method, comprising:
performing face feature extraction and body feature extraction on images to be processed to obtain image features of the images, wherein the image features include at least one of face features or body features, and the images to be processed include first images and second images;
performing a face clustering operation on the first images from which the face features are extracted according to the extracted face features to obtain a face clustering result;
performing a body clustering operation on the second images from which no face feature is extracted according to the face clustering result, the body features extracted from the second images, and the body features extracted from the first images from which the body features are extracted to obtain a body clustering result; and
obtaining a clustering result for the images to be processed according to the face clustering result and the body clustering result.

2. The method according to claim 1, wherein the face clustering result includes a first result, and performing the face clustering operation on the first images from which the face features are extracted according to the extracted face features to obtain the face clustering result includes:
acquiring a face clustering center of at least one existing category in an image database; and
performing face clustering according to the face clustering center of the at least one existing category and the face features extracted from the first images to cluster the first images into the existing category so as to obtain the first result of the first images.

3. The method according to claim 2, wherein the face clustering result further includes a second result, and performing the face clustering operation on the first images from which the face features are extracted according to the extracted face features to obtain the face clustering result further includes:
performing the face clustering operation on the first images which are not clustered into the existing category to obtain the second result of the first images.

4. The method according to claim 1, wherein the body clustering result includes a third result, and performing the body clustering operation on the second images from which no face feature is extracted according to the face clustering result, the body features extracted from the second images, and the body features extracted from the first images from which the body features are extracted to obtain the body clustering result includes:
performing the body clustering operation on any one of the second images according to the body features extracted from the first images from which the body features are extracted and the body features in the second images to obtain a body clustering sub-result;
determining the first images which belong to a same body category as the second images according to the body clustering sub-result; and
adding the second images into the category of the first images which belong to the same body category as the second images according to the face clustering result to obtain the third result.

5. The method according to claim 4, wherein the body clustering result further includes a fourth result, and performing the body clustering operation on any one of the second images from which no face feature is extracted according to the face clustering result, the body features extracted from the second images and the body features extracted from the first images from which the body features are extracted to obtain the body clustering result includes:
acquiring a body clustering center of at least one existing category in the image database; and
performing the body clustering operation on the second images which are not clustered into the face category according to the body features in the second images and the body clustering center of the at least one existing category to cluster the second images into the existing category so as to obtain the fourth result.

6. The method according to claim 1, wherein the method further comprises:
adding the images to be processed into the image database according to the clustering result; and
updating both the face clustering center and the body clustering center of at least one existing category in the image database according to the images to be processed.

7. An image processing device, comprising:
a processor; and
a memory configured to store processor executable instructions,
wherein the processor is configured to execute instructions stored by the memory, so as to:
perform face feature extraction and body feature extraction on images to be processed to obtain image features of the images, wherein the image features include at least one of face features or body features, and the images to be processed include first images and second images;
perform a face clustering operation on the first images from which the face features are extracted according to the extracted face features to obtain a face clustering result;
perform a body clustering operation on the second images from which no face feature is extracted according to the face clustering result, the body features extracted from the second images, and the body features extracted from the first images from which the body features are extracted to obtain a body clustering result; and
obtain a clustering result for the images to be processed according to the face clustering result and the body clustering result.

8. The image processing device according to claim 7, wherein the face clustering result includes a first result, and performing the face clustering operation on the first images from which the face features are extracted according to the extracted face features to obtain the face clustering result includes:
acquiring a face clustering center of at least one existing category in an image database; and
performing face clustering according to the face clustering center of the at least one existing category and the face features extracted from the first images to cluster the first images into the existing category so as to obtain the first result of the first images.

9. The image processing device according to claim 8, wherein the face clustering result further includes a second result, and performing the face clustering operation on the first images from which the face features are extracted according to the extracted face features to obtain the face clustering result further includes:
performing the face clustering operation on the first images which are not clustered into the existing category to obtain the second result of the first images.

10. The image processing device according to claim 7, wherein the body clustering result includes a third result, and performing the body clustering operation on the second images from which no face feature is extracted according to the face clustering result, the body features extracted from the second images, and the body features extracted from the first images from which the body features are extracted to obtain the body clustering result includes:
performing the body clustering operation on any one of the second images according to the body features extracted from the first images from which the body features are extracted and the body features in the second images to obtain a body clustering sub-result;
determining the first images which belong to a same body category as the second images according to the body clustering sub-result; and
adding the second images into the category of the first images which belong to the same body category as the second images according to the face clustering result to obtain the third result.

11. The image processing device according to claim 10, wherein the body clustering result further includes a fourth result, and performing the body clustering operation on any one of the second images from which no face feature is extracted according to the face clustering result, the body features extracted from the second images and the body features extracted from the first images from which the body features are extracted to obtain the body clustering result includes:
acquiring a body clustering center of at least one existing category in the image database; and
performing the body clustering operation on the second images which are not clustered into the face category according to the body features in the second images and the body clustering center of the at least one existing category to cluster the second images into the existing category so as to obtain the fourth result.

12. The image processing device according to claim 7, wherein the processor is further configured to:
add the images to be processed into the image database according to the clustering result; and
update both the face clustering center and the body clustering center of at least one existing category in the image database according to the images to be processed.

13. A non-transitory computer readable storage medium having computer program instructions stored thereon, wherein the computer program instructions, when executed by a processor, implement operations comprising:
performing face feature extraction and body feature extraction on images to be processed to obtain image features of the images, wherein the image features include at least one of face features or body features, and the images to be processed include first images and second images;
performing a face clustering operation on the first images from which the face features are extracted according to the extracted face features to obtain a face clustering result;
performing a body clustering operation on the second images from which no face feature is extracted according to the face clustering result, the body features extracted from the second images, and the body features extracted from the first images from which the body features are extracted to obtain a body clustering result; and
obtaining a clustering result for the images to be processed according to the face clustering result and the body clustering result.

14. The non-transitory computer readable storage medium according to claim 13, wherein the face clustering result includes a first result, and performing the face clustering operation on the first images from which the face features are extracted according to the extracted face features to obtain the face clustering result includes:
acquiring a face clustering center of at least one existing category in an image database; and
performing face clustering according to the face clustering center of the at least one existing category and the face features extracted from the first images to cluster the first images into the existing category so as to obtain the first result of the first images.

15. The non-transitory computer readable storage medium according to claim 14, wherein the face clustering result further includes a second result, and performing the face clustering operation on the first images from which the face features are extracted according to the extracted face features to obtain the face clustering result further includes:
performing the face clustering operation on the first images which are not clustered into the existing category to obtain the second result of the first images.

16. The non-transitory computer readable storage medium according to claim 13, wherein the body clustering result includes a third result, and performing the body clustering operation on the second images from which no face feature is extracted according to the face clustering result, the body features extracted from the second images, and the body features extracted from the first images from which the body features are extracted to obtain the body clustering result includes:
performing the body clustering operation on any one of the second images according to the body features extracted from the first images from which the body features are extracted and the body features in the second images to obtain a body clustering sub-result;
determining the first images which belong to a same body category as the second images according to the body clustering sub-result; and
adding the second images into the category of the first images which belong to the same body category as the second images according to the face clustering result to obtain the third result.

17. The non-transitory computer readable storage medium according to claim 16, wherein the body clustering result further includes a fourth result, and performing the body clustering operation on any one of the second images from which no face feature is extracted according to the face clustering result, the body features extracted from the second images and the body features extracted from the first images from which the body features are extracted to obtain the body clustering result includes:
acquiring a body clustering center of at least one existing category in the image database; and
performing the body clustering operation on the second images which are not clustered into the face category according to the body features in the second images and the body clustering center of the at least one existing category to cluster the second images into the existing category so as to obtain the fourth result.

18. The non-transitory computer readable storage medium according to claim 13, wherein the processor is further configured to:
add the images to be processed into the image database according to the clustering result; and
update both the face clustering center and the body clustering center of at least one existing category in the image database according to the images to be processed.
